(19) United States
(12) Patent Application Publication
(10) Pub. No.: US 2024/0191136 A1
(43) Pub. Date: Jun. 13, 2024

(54) METHODS AND COMPOSITIONS FOR DUST AND SOIL EROSION CONTROL

(71) Applicant: GMCO Corporation, Rifle, CO (US)

(72) Inventor: Bruce Juelfs, Windsor, CO (US)

(73) Assignee: GMCO Corporation, Rifle, CO (US)

(21) Appl. No.: 18/553,767

(22) PCT Filed: Apr. 27, 2022
(86) PCT No.: PCT/US22/26556

§ 371 Date: Oct. 3, 2023

Related U.S. Application Data
(60) Provisional application No. 63/180,539, filed on Apr. 27, 2021.

(51) Int. Cl. C09K 17/32; C08K 5/1545; C08L 97/00; C09K 3/22; E01C 21/00; E02D 3/12

(52) U.S. Cl. CPC C09K 17/32; C08K 5/1545; C08L 97/005; C09K 3/22; E01C 21/00; E02D 3/12; E02D 2300/0045

(57) ABSTRACT

A composition as described herein for treating an exposed area for dust control and soil erosion stabilization is provided, the composition comprising: (i) about 30 to about 80% dissolved biopolymer solution by volume; (ii) about 10 to about 20% dissolved carbohydrate solution by volume; (iii) about 0.02 to about 0.25% nonionic surfactant solution by volume; and (iv) water that makes up a remaining volume to 100% wherein the composition is effectively free from magnesium chloride and calcium chloride. In one aspect, the composition as described herein may be free, substantially free, or effectively free from oil-based and hydrophobic content. A method for using the composition to treat an exposed surface for dust control and soil erosion stabilization is also provided.

### CROSS-REFERENCE TO RELATED APPLICATIONS

This application claims priority from U.S. Provisional Patent Application No. 63/180,539, filed on Apr. 27, 2021, which is incorporated by reference herein in its entirety.

### BACKGROUND

Dust generation is a common problem found on rural roads, transportation thoroughfares, mines, mineral storage piles, tailings storage, and other areas where particulates may be generated and dispersed into the air and onto surrounding surfaces. A common method that has been used to suppress and control the dust consists of merely wetting down the area with water. This wetting method is effective for only a very limited duration. Once the water evaporates, the benefit evaporates with it, while a tremendous amount of water resources are expended. To enhance the surface moisture retention, hygroscopic salts such as magnesium chloride and calcium chloride may be added to the water or to the composition used for dust control. Alternately, the surface area for dust control may be sprayed with an oil-based or a hydrophobic composition. Though effective for dust control, a high usage of either salts or oil may have undesired environmental impacts, including contamination to underground water, to vegetation, and to wildlife.

What is needed is an effective dust control agent that has a minimal impact on the environment.

### BRIEF DESCRIPTION OF THE FIGURES

The accompanying figures, which are incorporated in and constitute a part of the specification, are used merely to illustrate various example aspects.

FIG. 1 illustrates an example of a method for applying a composition as disclosed herein on an exposed surface for dust control and soil erosion stabilization.

FIG. 2 illustrates an example preparation of an exposed surface prior to applying a composition as disclosed herein.

FIG. 3 illustrates grading and compacting an exposed surface prior to applying a composition as disclosed herein.

FIGS. 4A and 4B illustrate examples of equipment applying a composition as disclosed herein to an exposed surface for dust control and soil erosion stabilization.

FIG. 5 illustrates an ambient temperature cured surface having dust control and soil erosion stabilization properties.

FIG. 6 is a graph of surface hardness penetration depth over time using one example of the claimed methods and compositions.

### SUMMARY

A composition is provided for treating an exposed area for dust control and soil erosion stabilization, the composition comprising: (i) about 30 to about 80% dissolved biopolymer solution by volume; (ii) about 10 to about 20% dissolved carbohydrate solution by volume; (iii) about 0.001 to about 0.25% nonionic surfactant solution by volume; and (iv) water that makes up a remaining volume to 100%, wherein the composition is free, substantially free, or effectively free of magnesium chloride and calcium chloride. In one aspect, the composition as described herein is further free, substantially free, or effectively free from oil-based and hydrophobic content.

In another aspect, a method is provided for treating an exposed surface for dust control and soil erosion stabilization, the method comprising: applying to the exposed surface a composition comprising: (i) about 30 to about 80% dissolved biopolymer solution by volume; (ii) about 10 to about 20% dissolved carbohydrate solution by volume; (iii) about 0.001 to about 0.25% nonionic surfactant solution by volume; and (iv) water that makes up a remaining volume to 100%, wherein the composition is free, substantially free, or effectively free from magnesium chloride and calcium chloride. In one aspect, the composition as described herein is further free, substantially free, or effectively free from oil-based and hydrophobic content.

When the exposed surface is a road, a path, or a graded slope, the method may further comprise applying the composition as described herein topically and horizontally. In one aspect, the applying may be at a pre-determined rate in, e.g., gallons per square yard, to a pre-determined depth of tilled surface. In one aspect, the method further comprises curing at ambient temperature to form a tacky surface to provide dust control and soil erosion stabilization.

### DETAILED DESCRIPTION

The disclosure describes an environmentally friendly composition as described herein for dust control and soil erosion stabilization, as well as a method for applying the composition to achieve long lasting efficacy. More specifically, the composition may be a mixture of water soluble components from natural sources. Unlike most known compositions that contain at least a metal chloride salt (see, e.g., U.S. Pat. No. 7,157,021, the disclosure of which is incorporated by reference herein in its entirety), oil-based content, or both for dust control on an applied surface, the blended mixture is free, substantially free, or effectively free from magnesium chloride, calcium chloride, and other such metal salts, and is free, substantially free, or effectively free of oil-based and hydrophobic content.

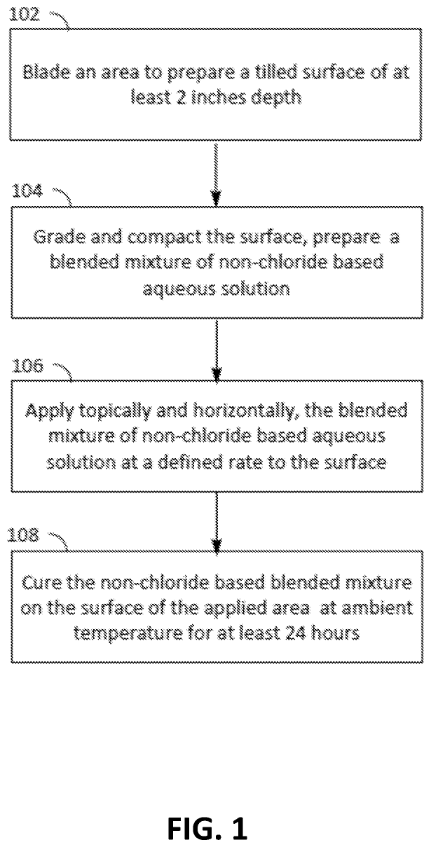

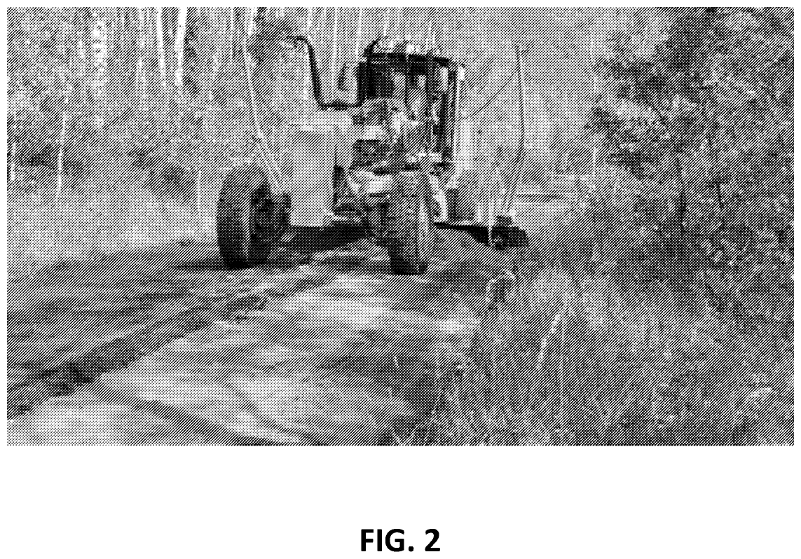

FIG. 1 illustrates an example of a method for applying a non-chloride (that is, non-metal chloride) based composition as described herein on an exposed surface for dust control and soil erosion stabilization. In step 102, prior to applying the composition, the exposed surface is prepared. In an example, if the exposed surface of the area is a road, a path, or a slope, the surface may be cleared of vegetation and tilled or bladed to loosen the soil to a depth of about two to about six inches by earth moving equipment, such as shown in FIG. 2. The blading and tilling may enable the composition to penetrate to a certain depth of the topsoil after curing.

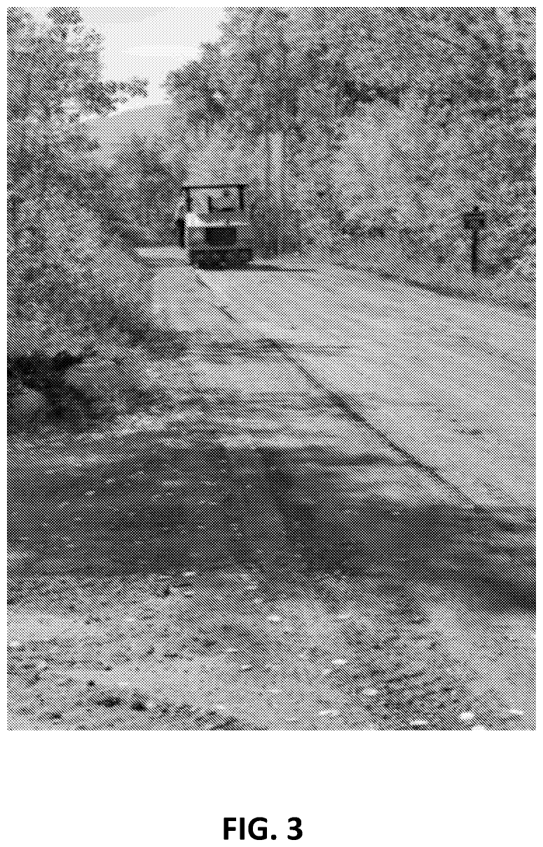

FIG. 3 illustrates grading and compacting the exposed surface prior to applying the composition. The grading and compacting of the tilled surface may be part of the surface preparation process, that is, to ensure that the composition is applied to a smooth and firm surface that does not get torn or ripped easily due to traffic, yet still allows the dispensed composition to soak and penetrate to a certain depth beneath the exposed surface.

In an example, the composition as described herein may include about 30 to about 80% dissolved biopolymer solution by volume, about 10 to about 20% dissolved carbohydrate solution by volume, about 0.001 to about 0.25% nonionic surfactant solution by volume, and water that makes up a remaining volume to 100%, wherein the composition is free, substantially free, or effectively free from magnesium chloride and calcium chloride.

### Biopolymers

In one aspect, the dissolved biopolymer solution may include about 5 to about 35% lignin by weight, about 5 to about 20% sugars by weight, and about 45 to about 90% water by weight. In another aspect, the dissolved biopolymer solution comprises about 5 to about 30% lignin by weight, about 1 to about 5% sugars by weight, and about 45 to about 95% water by weight.

In one aspect, the biopolymer may be a commercially available product such as a wheat straw liquor produced by Columbia Pulp, LLC under the brand name CBP-SurTac. The biopolymer product (e.g., wheat straw liquor) has shown to resist water better than typical lignins produced from soft or hard woods.

In another aspect, the biopolymer may be a commercially available sugarcane/bagasse extract comprising water (45-95%), lignin (5-30%), and sugars (1-5%), manufactured by Tellus Products LLC under the brand name Tellus BioPolymer Coproduct.

### Carbohydrate Solutions

In one aspect, the dissolved carbohydrate solution may comprise a dissolved monosaccharide solution. In one aspect, the dissolved carbohydrate solution may comprise a corn syrup solution. In one aspect, the dissolved carbohydrate solution may comprise a sugar-water solution having approximately 15 to 80 percent by weight of a dissolved sugar solid, wherein the dissolved sugar solid contains approximately 2-60 percent by weight of a monosaccharide. Suitable such dissolved carbohydrate solutions are disclosed in U.S. Pat. No. 6,468,442, which is incorporated by reference herein in its entirety, and are sold under the brand name Caliber®.

Adhesion qualities (for long term stabilization and dust control) may be enhanced by the addition of the carbohydrates such as the Caliber® corn product to form adhesive bonds needed for long term stabilization and dust control.

### Nonionic Surfactants

In one aspect, the surfactant may be a commercially available blend of non-ionic surfactants such as such as the WETT dust control nonionic surfactant produced by Paradigm Group LLC. In one aspect, the surfactants may be nonionic surfactants comprising fatty alcohol ethoxylates, alkyl phenol ethoxylates, and fatty acid alkoxylates. In one aspect, the surfactants may be nonionic surfactants comprising polyoxyethylene-type nonionic surfactants or sucrose fatty acid esters. Suitable surfactants may include alkyl polyglycoside, cetomacrogol 1000, cetostearyl alcohol, cetyl alcohol, cocamide DEA, cocamide MEA, decyl glucoside, decyl polyglucose, glycerol monostearate, IGEPAL CA-630, isoceteth-20, lauryl glycoside, maltoside, monolaurin, mycosubtilin, narrow-range ethoxylate, nondidet p-40, nonoxynol-9, nonoxynols, NP-40, octaethylene glycol monododecyl ether, N-octyl beta-D-thioglucopyranoside, octyl glucoside, oleyl alcohol, pentaethylene glycol monododecyl ether, polidocanol, poloxamer, polxamer 407, polyethoxylated tallow amine, polyglycerol polyricinoleate, polysorbate, polysorbate 20, polysorbate 80, sorbitan, sorbitan monolaurate, sorbitan monostearate, sorbitan tristearate, stearyl alcohol, surfactin, triton X-100, and tween 80.

### Method for Treatment

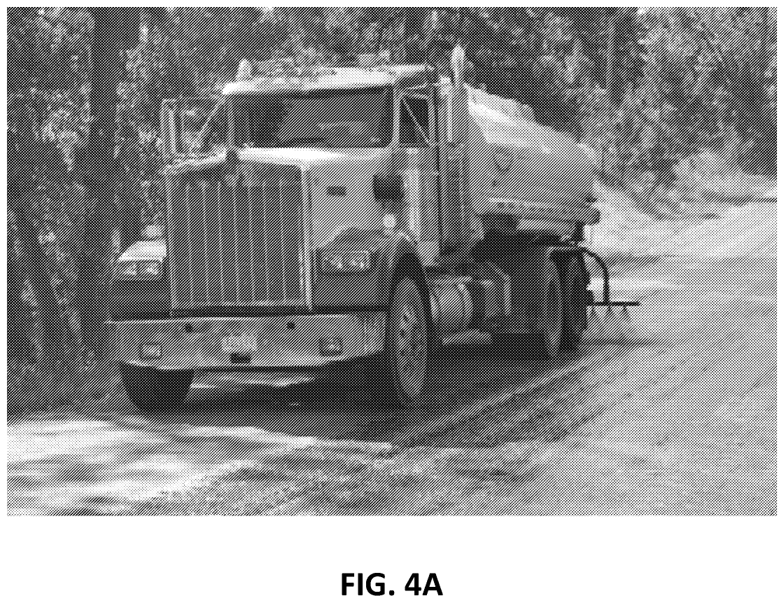

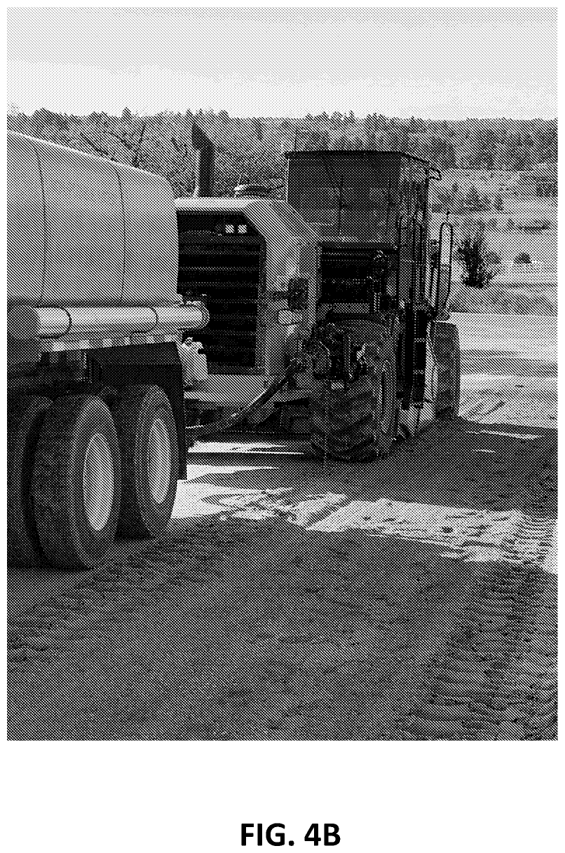

The composition as described herein may be mixed and blended to any volume for dispensing at above about 32° F. For example, the composition as described herein may be mixed and blended to fill up a 5,000 gallon tank that is mounted on a truck as shown in FIGS. 4A and 4B for application.

FIG. 4A illustrates that the composition may be applied topically and through a horizontal shaft mixer at the prepared surface. FIG. 4B illustrates that the composition may be applied topically through injection or spraying while simultaneously performing soil tilling and grading using a motor grader. For example, the composition as described herein may be applied at a rate of at least about 0.1 gallon per square yard per inch depth of surface coverage when blended with the soil below the compacted surface. Therefore, to sufficiently seal the surface, the equipment in FIG. 4A or 4B may dispense at a flow rate of at least about 0.2 gallon per square yard of surface coverage to stabilize about two inches of soil below the surface for dust or soil erosion control.

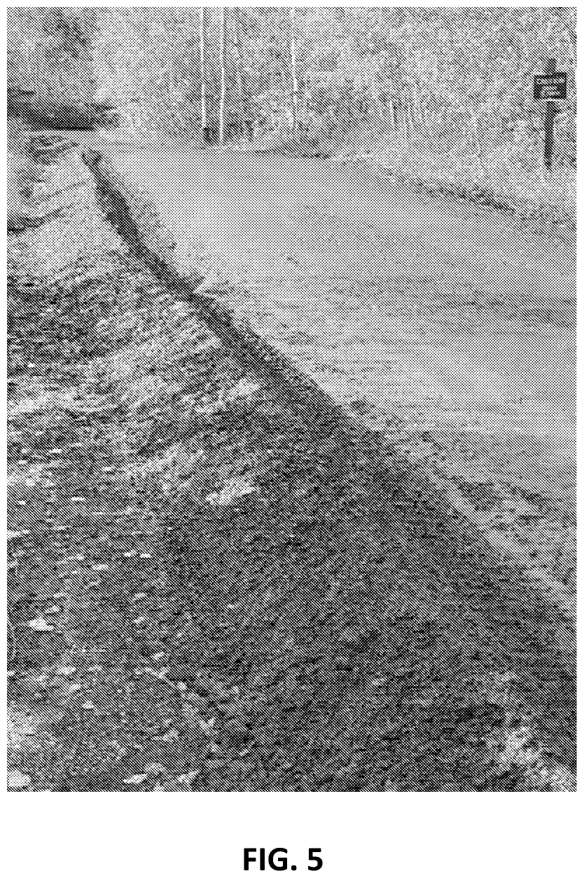

FIG. 5 illustrates that subsequent to the applying or injection of the composition, the top soil with the composition may be cured at ambient temperature for at least about 24 hours to allow an adhesive film to form on the surface of the soil by a mixture of the biopolymer and the carbohydrate through natural evaporation at an ambient temperature.

### Examples

The following compositions were prepared and tested:

### Composition 1:

| Component | % by volume | Gallons |
|---|---|---|
| CBP-SurTac ™ biopolymer | 64 | 3,200 |
| Caliber ® corn syrup | 15.98 | 799.2 |
| WETT ™ surfactant | 0.02 | 1 |
| Water | 19.996 | 999.8 |

### Composition 2:

| Component | % by volume | Gallons |
|---|---|---|
| CBP-SurTac ™ biopolymer | 40.00 | 2,000 |
| Caliber ® corn syrup | 10.00 | 500 |
| WETT ™ surfactant | 0.02 | 1 |
| Water | 49.98 | 2,499 |
| | 100 | 5,000 |

### Composition 3:

| Component | % by volume | Gallons |
|---|---|---|
| CBP-SurTac ™ biopolymer | 64.00 | 3,200 |
| Caliber ® corn syrup | 16.00 | 800 |
| WETT ™ surfactant | 0.0050 | 0.25 |
| Water | 19.9950 | 999.75 |
| | 100 | 5,000 |

### Composition 4:

| Component | % by volume | Gallons |
|---|---|---|
| Tellus BioPolymer | 64.00 | 3,200 |
| Coproduct ™ biopolymer | | |
| Caliber ® corn syrup | 16.00 | 800 |
| WETT ™ surfactant | 0.0050 | 0.25 |
| Water | 19.9950 | 999.75 |
| | 100 | 5,000 |

Compositions 1-4 can accommodate a significant amount of dust or debris blown or dropped onto the road surface. Moisture from dew, fog, rain, snow, or light water precipitation may activate the carbohydrates (sugars) in the biopolymer and/or the carbohydrate solution to provide tackiness without the use of chloride salt or hydrophobic content.

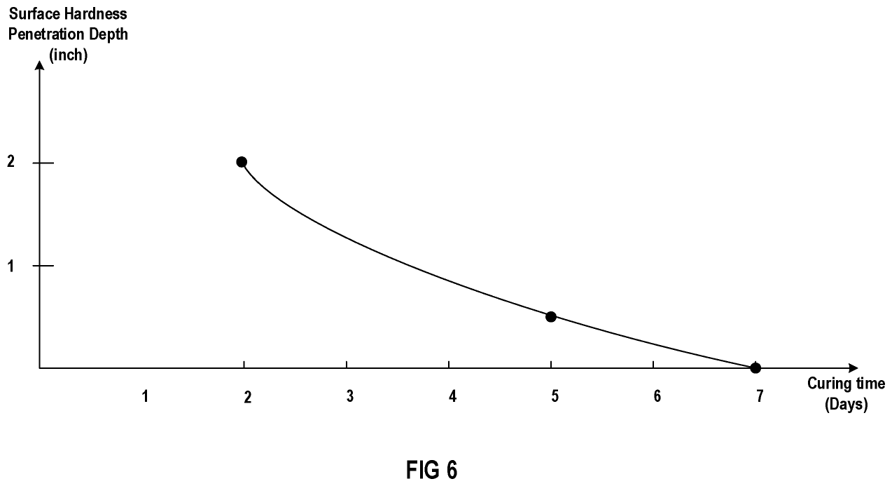

FIG. 6 is a graph of surface hardness penetration depth over time using Composition 2. Experimental surface hardness evaluation following curing the applied composition on a road section was performed using penetration depth by a steel probe over seven days:

| Days After | Visual Characterization | Depth of Steel Probe |
|---|---|---|
| Application | of Surface | Penetration (inches) |
| 2 | Compact | 2 |
| 5 | Tight | 0.5 |
| 7 | Hard | 0 |

The curing temperatures during the seven days ranged from 80-90 ºF with overnight lows between 45-50° F.

After fully cured, a tacky or sticky surface is formed that holds particulates that contact the surface of the area from tires or from the wind, thus providing dust control and soil erosion stabilization to the area. In implementation, the surfactant in the composition may reduce surface tension of a viscous aqueous blended mixture of the composition to enable a deeper penetration of the composition below the exposed surface of the soil, thus enhancing effectiveness and service life.

For exposed surfaces other than road sections (e.g., a wall of a mine or construction site), the composition as described herein may be directly applied to the exposed surface by other means, such as spraying.

The term “about” in conjunction with a number is intended to include ±10% of the number. This is true whether “about” is modifying a stand-alone number or modifying a number at either or both ends of a range of numbers. In other words, “about 10” means from 9 to 11. Likewise, “about 10 to about 20” contemplates 9 to 22 and 11 to 18. In the absence of the term “about,” the exact number is intended. In other words, “10” means 10.

Unless otherwise specified, “a,” “an,” “the,” “one or more of,” and “at least one” are used interchangeably. The singular forms “a”, “an,” and “the” are inclusive of their plural forms. The recitations of numerical ranges by endpoints include all numbers subsumed within that range (e.g., 1 to 5 includes 1, 1.5, 2, 2.75, 3, 3.80, 4, 5, etc.). The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. For every use of the terms “including” and “comprising” herein, it is explicitly contemplated that the same composition or action may be subjected to the terms “consisting of” or “consisting essentially of” (each having its well-known and legally accepted meaning). Only a desire for brevity militates against listing all three alternatives with respect to each component of each composition. To be “effectively free” of a substance is meant that the composition or method may include the substance, but only in an amount that does not materially alter the basic and novel characteristics of the claimed composition or method. The phrase “selected from the group consisting of” is meant to include mixtures of the listed group.

It is not the intention of the applicants to restrict or in any way limit the scope of the appended claims to such detail if such detail is not recited in the claims. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and example embodiments shown and described. Accordingly, departures may be made from such details without departing from the spirit or scope of the general inventive concept. Thus, this application is intended to embrace alterations, modifications, and variations that fall within the scope of the appended claims. The scope of the invention is to be determined by the appended claims and their equivalents.

What is claimed is:

1. A composition, comprising:
(i) about 30 to about 80% dissolved biopolymer solution by volume;
(ii) about 10 to about 20% dissolved carbohydrate solution by volume;
(iii) about 0.02 to about 0.25% nonionic surfactant solution by volume; and
(iv) water that makes up a remaining volume to 100%,
wherein the composition is effectively free of magnesium chloride and calcium chloride.

2. The composition according to claim 1, wherein the dissolved biopolymer solution comprises about 5 to about 35% lignin by weight, about 5 to about 20% sugars by weight, and about 45 to about 90% water by weight.

3. The composition according to claim 1, wherein the dissolved biopolymer solution comprises about 5 to about 30% lignin by weight, about 1 to about 5% sugars by weight, and about 45 to about 95% water by weight.

4. The composition according to any of the preceding claims, wherein the dissolved carbohydrate solution comprises one or more of: a dissolved monosaccharide solution and a corn syrup solution.

5. The composition according to any of the preceding claims, wherein the lignin comprises one or more of: a wheat straw-derived lignin, sugarcane/bagasse-derived lignin, and a lignin sulfonate.

6. The composition according to any of the preceding claims, wherein the composition is effectively free of oil based or hydrophobic content.

7. The composition according to claim 1, consisting essentially of about 64% by volume of wheat straw liquor as the dissolved biopolymer solution; about 16% by volume of corn syrup as the dissolved carbohydrate solution; about 0.02% by volume of the surfactant solution; and water.

8. The composition according to claim 1, consisting essentially of about 40% by volume of wheat straw liquor as the dissolved biopolymer solution; about 10% by volume of corn syrup as the dissolved carbohydrate solution; about 0.02% by volume of the surfactant solution; and water.

9. The composition according to claim 1, consisting essentially of about 64% by volume of wheat straw liquor as the dissolved biopolymer solution; about 16% by volume of corn syrup as the dissolved carbohydrate solution; about 0.005% by volume of the surfactant solution; and water.

10. The composition according to claim 1, consisting essentially of about 64% by volume of sugarcane/bagasse extract as the dissolved biopolymer solution; about 16% by volume of corn syrup as the dissolved carbohydrate solution; about 0.005% by volume of the surfactant solution; and water.

11. A method for treating an exposed surface for dust control and soil erosion stabilization, the method comprising:
applying to an exposed surface a composition, the composition comprising:
(i) about 30 to about 80% dissolved biopolymer solution by volume;
(ii) about 10 to about 20% dissolved carbohydrate solution by volume;
(iii) about 0.02 to about 0.25% nonionic surfactant solution by volume; and
(iv) water that makes up a remaining volume to 100%,
wherein the composition is effectively free from magnesium chloride and calcium chloride.

12. The method according to claim 11, wherein the dissolved biopolymer solution comprises about 5 to about 35% lignin by weight, about 5 to about 20% sugars by weight, and about 45 to about 90% water by weight.

13. The method according to claim 11, wherein the dissolved biopolymer solution comprises about 5 to about 30% lignin by weight, about 1 to about 5% sugars by weight, and about 45 to about 95% water by weight.

14. The method according to any of claims 11-13, wherein the dissolved carbohydrate solution comprises one or more of: a dissolved monosaccharide solution and a corn syrup solution.

15. The method according to any of claims 11-14, wherein the lignin comprises one or more of: a wheat straw-derived lignin, a sugarcane/bagasse-derived lignin, and a lignin sulfonate.

16. The method according to claim 11, wherein the composition consists essentially of about 64% by volume of wheat straw liquor as the dissolved biopolymer solution; about 16% by volume of corn syrup as the dissolved carbohydrate solution; about 0.02% by volume of the surfactant solution; and water.

17. The method according to claim 11, wherein the composition consists essentially of about 40% by volume of wheat straw liquor as the dissolved biopolymer solution; about 10% by volume of corn syrup as the dissolved carbohydrate solution; about 0.02% by volume of the surfactant solution; and water.

18. The method according to claim 11, wherein the composition consists essentially of about 64% by volume of wheat straw liquor as the dissolved biopolymer solution; about 16% by volume of corn syrup as the dissolved carbohydrate solution; about 0.005% by volume of the surfactant solution; and water.

19. The method according to claim 11, wherein the composition consists essentially of about 64% by volume of sugarcane/bagasse extract as the dissolved biopolymer solution; about 16% by volume of corn syrup as the dissolved carbohydrate solution; about 0.005% by volume of the surfactant solution; and water.

20. The method according to any of claims 11-19, wherein the composition is effectively free from oil based or hydrophobic content.

21. The method according to any of claims 11-20, wherein the composition is blended to fill a tank capacity suitable for application by a dispensing equipment.

22. The method according to any of claims 11-21, wherein when the exposed surface is a road, a path, or a graded slope, the method further comprises blading or tilling the exposed surface to a depth of about 2 to about 6 inches and grading or compacting the bladed or tilled surface prior to applying the composition.

23. The method according to any of claims 11-22, wherein when the exposed surface is a road, a path, or a graded slope, the method comprises:
applying topically and horizontally sufficient to inject the composition at least a depth of about 2 to about 6 inches below the graded and compacted surface, at a rate of at least about 0.1 gallon per square yard per inch depth of the graded and compacted surface.

24. The method according any of claims 11-23, further comprising:
curing at an ambient temperature above 40° F., the composition as described herein for at least about 24 hours through natural evaporation.
